(19) United States
(12) Patent Application Publication
(10) Pub. No.: US 2023/0146830 A1
(43) Pub. Date: May 11, 2023

(54) METHOD, COMPUTER PROGRAM AND APPARATUS FOR INVOKING A TELE-OPERATED DRIVING SESSION

(71) Applicant: VOLKSWAGEN AKTIENGESELLSCHAFT, Wolfsburg (DE)

(72) Inventors: Guillaume JORNOD, Berlin (DE); Andreas PFADLER, Berlin (DE)

(21) Appl. No.: 17/995,472

(22) PCT Filed: Apr. 6, 2021
(86) PCT No.: PCT/EP2021/058899

§ 371 Date: Oct. 4, 2022

(30) Foreign Application Priority Data
Apr. 9, 2020 (EP) 20168864.5

(51) Int. Cl. B60W 60/00; H04W 24/08; B60W 30/14

(52) U.S. Cl. CPC B60W 60/005; H04W 24/08; B60W 60/0015; B60W 30/146; B60W 2520/00; B60W 2554/20; B60W 2556/45

(57) ABSTRACT

A method, a computer program, and an apparatus for invoking a tele-operated driving session and a transportation vehicle equipped with an automated driving function using the method or apparatus. An impending situation that requires a tele-operated driving session is identified, a quality of service for a communication between the transportation vehicle and a control center is predicted for a location where the tele-operated driving session will be performed, the speed of the transportation vehicle is reduced to a maximum drivable speed for a tele-operated driving session with the predicted quality of service, and the tele-operated driving session is initiated.

### PRIORITY CLAIM

This patent application is a U.S. National Phase of International Patent Application No. PCT/EP2021/058899 filed 6 Apr. 2021, which claims priority to European Patent Application No. 20168864.5, filed 9 Apr. 2020, the disclosures of which are incorporated herein by reference in their entireties.

### SUMMARY

Illustrative embodiments relate to a method, a computer program, and an apparatus for invoking a tele-operated driving session for a transportation vehicle equipped with an automated driving function. Illustrative embodiments further relate to a transportation vehicle equipped with an automated driving function, which makes use of such a method or apparatus.

### BRIEF DESCRIPTION OF THE DRAWINGS

Disclosed embodiments will be described in more detail below with reference to the figures, in which:

FIG. 1 schematically illustrates an exemplary method for invoking a tele-operated driving session for a transportation vehicle equipped with an automated driving function;

FIG. 2 schematically illustrates a first exemplary embodiment of an apparatus for invoking a tele-operated driving session for a transportation vehicle equipped with an automated driving function;

FIG. 3 schematically illustrates a second exemplary embodiment of an apparatus for invoking a tele-operated driving session for a transportation vehicle equipped with an automated driving function;

FIG. 4 illustrates a basic architecture of a V2V and V2X communication system;

FIG. 5 shows a block diagram of an electronics system of a transportation vehicle;

FIG. 6 shows an exemplary deadlock situation as an application scenario of tele-operated driving;

FIG. 7 shows an estimated probability of a deadlock along a path of a transportation vehicle equipped with an automated driving function;

FIG. 8 shows a predicted quality of service of communication with a control center along a path of a transportation vehicle equipped with an automated driving function; and

FIG. 9 shows a comparison between speed profiles with and without the present solution.

### DETAILED DESCRIPTION

Tele-operated driving is gathering more and more interest. Tele-operated driving in the present context means that an external operator controls a transportation vehicle remotely. The external operator is located in a control center. There may be a large distance between the control center and the transportation vehicle. The control center and the transportation vehicle are connected via a radio communication system and its backhaul. Primarily, the radio communication system is part of a public mobile communication system such as LTE (Long Term Evolution) or 5G.

Tele-operated driving belongs to safety-related time-critical applications. Main requirements for the exchange of information are low latency, high data rate, and high reliability.

Autonomous driving, also referred to as automatic driving, automated driving, or piloted driving, is the movement of transportation vehicles, mobile robots and driverless transport systems that are largely autonomous. There are different degrees of autonomous driving. In Europe, various transport ministries, for example, the Federal Institute for Road Systems (Bundesanstalt für Straβenwesen) in Germany, have defined the following autonomous stages:
Level 0: ,,Driver only”, the driver drives himself, steers, accelerates, brakes, etc.
Level 1: Certain assistance systems help with transportation vehicle operation, including a cruise control system such as ACC (Automatic Cruise Control).
Level 2: Partial automation. Therein, automatic parking, tracking function, general longitudinal guidance, acceleration, deceleration, etc. are taken over by the assistance systems, including collision avoidance.
Level 3: High automation. The driver does not have to monitor the system continuously. The transportation vehicle independently performs functions such as the triggering of the turn signal, lane change and tracking. The driver can turn to other things, but if requested, the driver has to take over control within a pre-warning period.
Level 4: Full automation. The guidance of the transportation vehicle is permanently performed by the system. If the system is no longer able to handle the tasks, the driver can be asked to take over control.
Level 5: No driver required. Apart from setting the target and starting the system, no human intervention is required.

A slightly different definition of levels is known from the Society of Automotive Engineers (SAE). In this regard, reference is made to the SAE J3016 standard. Such definitions could also be used instead of the above given definition.

Tele-operated driving might become a key technology to solve issues with Level 4 and Level 5 driven transportation vehicles. A transportation vehicle driving autonomously makes its decisions based on the perception of its environment as well as on predefined traffic regulations. However, it may happen that an autonomous transportation vehicle is no longer able to continue its planned route, e.g., due to an incorrect interpretation of the environment, sensor failures, poor road conditions, or unclear traffic conditions, e.g., an accident or a construction site. In such situations, the transportation vehicle needs external instructions from someone else to solve the situation, e.g., the external operator located in the control center. The transportation vehicle will be driven remotely by the external operator during a tele-operated driving session until the transportation vehicle can resume its autonomous driving operation.

In this regard, US 2017/0308082 A1 discloses a method for assisting autonomous vehicles. While the vehicle is operating autonomously, it can alert a control center or open a dialogue with the control center if an event occurs. Events can include a variety of situations, including deadlock situations. Deadlock situations can occur when the autonomous vehicle software analysis reaches a threshold uncertainty level or a threshold risk level, or when there is a failure of autonomous control.

US 2019/0049948 A1 discloses methods for operating a vehicle by switching between an autonomous control system within the vehicle and a remote operator. When operating in full-autonomy, a vehicle operation system can check for a fail-operational condition. When such a condition is detected, the vehicle operation system can concurrently reduce the vehicle speed and send a distress call to a remote operator.

WO 2018/141415 A1 discloses a method for enabling remote control of a vehicle. The method is performed by a vehicle data provider. When the vehicle data provider detects a need for manual assistance by a remote operator, a stream of vehicle data relating to a time prior to when remote control starts is obtained. The vehicle data are modified by adjusting a duration of playback. The modified vehicle data are then provided for playback to the operator.

US 2017/0192423 A1 discloses a method for remotely assisting an autonomous vehicle. Sensor data from the autonomous vehicle is aggregated and an assistance-desired scenario is identified. Based on the sensor data, an assistance request is generated, which is transmitted to a remote assistance interface. A response to the assistance request is then received and processed.

It is known that the performance of tele-operated driving is related to the communication link performance. This link comprises the air interface between the transportation vehicle and a base station and further the connection through the operator backbone, i.e., the core network. Notably, the driving parameters for tele-operated driving, like the maximum speed, have to be adapted to the communication quality with the command center. With present solutions for tele-operated driving, when a deadlock occurs, the transportation vehicle needs to stop, contact the control center and start a tele-operated driving session. This creates an interruption of the driving experience. A smooth takeover is not possible yet.

Disclosed embodiments provide improved solutions for invoking a tele-operated driving session for a transportation vehicle.

This is achieved by a disclosed method, by a disclosed computer program, which implements this method, and by a disclosed apparatus. The dependent claims include further developments and improvements of the present principles as described below.

According to a first disclosed embodiment, a method for invoking a tele-operated driving session for a transportation vehicle equipped with an automated driving function comprises:
identifying an impending situation that may require a tele-operated driving session;
predicting a quality of service for a communication between the transportation vehicle and a control center for a location where the tele-operated driving session should be performed; and
reducing a speed of the transportation vehicle to a maximum drivable speed for a tele-operated driving session with the predicted quality of service.

Accordingly, a computer program comprises instructions, which, when executed by at least one processor, cause the at least one processor to perform the following operations for invoking a tele-operated driving session for a transportation vehicle equipped with an automated driving function:
identifying an impending situation that may require a tele-operated driving session;
predicting a quality of service for a communication between the transportation vehicle and a control center for a location where the tele-operated driving session should be performed; and
reducing a speed of the transportation vehicle to a maximum drivable speed for a tele-operated driving session with the predicted quality of service.

The term computer has to be understood broadly. It also includes electronic control units, embedded devices and other processor-based data processing devices.

The computer program code can, for example, be made available for electronic retrieval or stored on a computer-readable storage medium.

According to another disclosed embodiment, an apparatus for invoking a tele-operated driving session for a transportation vehicle equipped with an automated driving function comprises:
an identifying module configured to identify an impending situation that may require a tele-operated driving session;
a predicting module configured to predict a quality of service for a communication between the transportation vehicle and a control center for a location where the tele-operated driving session should be performed; and
a speed control module configured to reduce a speed of the transportation vehicle to a maximum drivable speed for a tele-operated driving session with the predicted quality of service.

According to the disclosed embodiments, the automated transportation vehicle not only determines that a tele-operated driving session may be required in the near future, e.g., due to a deadlock situation, but also predicts a quality of service for the communication link that will be used during this tele-operated driving session. Based on the given situation, especially the predicted quality of service, a maximum drivable speed is calculated for the tele-operated driving session. The speed of the automated transportation vehicle is then reduced, if necessary, to this maximum drivable speed as a preparative action. Reducing the speed to the maximum drivable speed in advance avoids a potential emergency brake of the automated transportation vehicle and thus leads to a smoother takeover.

For predicting the quality of service for the communication link, several options exist. In accordance with a first option, the quality of service can be estimated by the transportation vehicle itself. For example, in the article by G. Jornod et al.: “Packet Inter-Reception Time Conditional Density Estimation Based on Surrounding Traffic Distribution”, IEEE Open Journal of Intelligent Transportation Systems, Vol. 1 (2020), pp. 51-62, a prediction model for packet inter-reception time platoon messages in an IEEE 802.11p network is presented. In accordance with a second option, the quality of service can be provided by the network. In Release 16, the 3GPP standard setting organization introduced a solution that allows a cellular 5G communication system to notify a V2X (Vehicle-to-Everything) application of an expected or estimated change of quality of service before it actually occurs. This procedure is referred to as quality of service sustainability analytics in the 3GPP standards and helps the V2X application to decide in a proactive and safe manner if there is need for an application change. Further details can be found, for example, in the 3GPP Technical Specification TS 23.287: “Architecture enhancements for 5G System (5GS) to support Vehicle-to-Everything (V2X) services (v16.1.0, Release 16)”, or the 3GPP Technical Specification TS 23.288: “Architecture enhancements for 5G System (5GS) to support network data analytics services (v16.2.0, Release 16)”.

In an exemplary embodiment, the tele-operated driving session is initiated once it is confirmed that the tele-operated driving session is required. As stated above, the automated transportation vehicle reduces its speed to a maximum drivable speed in preparation of a situation that may require a tele-operated driving session. Of course, it may later turn out that in fact no tele-operated driving session is necessary. However, once it is confirmed that a tele-operated driving session is actually needed, the automated transportation vehicles initiates this session. In this way, the control center is contacted sufficiently in advance to ensure a timely takeover of control by the control center.

In an exemplary embodiment, a probability is determined that a tele-operated driving session is required, wherein an impending situation that may require a tele-operated driving session is identified when the probability is above a first threshold. Under real operating conditions, it will often be difficult to make a definite decision at an early stage as to whether a tele-operated driving session will actually be required. Therefore, it is advisable to rely on probabilities. For example, the automated transportation vehicle may continuously determine and evaluate the probability of a deadlock situation. Once this probability is sufficiently high, the necessary actions for handling the deadlock are initiated, i.e., the transportation vehicle gathers information on the predicted quality of service and reduces the speed accordingly. Of course, information on the predicted quality of service may likewise be gathered continuously, irrespective of a deadlock situation. The value of the first threshold can be chosen such that a tradeoff is achieved between a smooth reduction of the transportation vehicle speed and a number of unnecessary speed reductions. If the first threshold is set very low, the automated transportation vehicle will reduce its speed in many situations where actually no tele-operated driving session is needed. If the first threshold is set very high, it may occur that the automated transportation vehicle will need to brake rather sharply to achieve the maximum drivable speed in time. Determination of an appropriate value for the first threshold is at the discretion of the skilled person.

For determining a probability that a tele-operated driving session is required, use may be made of a perception uncertainty of the transportation vehicle sensors. Transportation vehicle sensors, like LIDAR or RADAR sensors, usually provide a confidence level. The higher the perception uncertainty, the higher is the probability that a tele-operated driving session will be needed. Alternatively or in addition, environmental information may be evaluated. For example, the area in which the transportation vehicle is driving may be taken into account. The probability for the need for a tele-operated driving session is higher in urban areas than on a highway or in rural areas. Likewise, it may be analyzed whether other transportation vehicles in this area are already in a tele-operated driving session. If this is the case, the probability of the need for a tele-operated driving session is higher. The information required for this analysis may be shared via broadcasting, for example. Other environmental information that may be evaluated are weather conditions and traffic information. The probability that a tele-operated driving session is required is higher for bad weather conditions, such as snow, hell stones, fog, etc., than for sunny weather. Likewise, the probability is higher in case of a detected traffic jam or a high vehicle density than for a low vehicle density. The above described analysis may be combined with an approach based on statistics, experience or learning. Such an approach takes into account how often the conditions regarding perception uncertainty and environmental information have led to a tele-operated driving session.

In an exemplary embodiment, it is confirmed that the tele-operated driving session is required when the probability is above a second threshold. Confirmation of the necessity of a tele-operated driving session based on the probability has the benefit that the control center can be contacted rather early, which increases the time available for an operator to take over control. The value of the second threshold can be chosen such that a tradeoff between a smooth handover to the control center and a number of unnecessarily invoked tele-operated driving sessions is achieved. As before, determination of an appropriate value for the second threshold is at the discretion of the skilled person. Of course, confirmation of the necessity of a tele-operated driving session can also be obtained through a user input, e.g., actuation of a press button by a driver.

In an exemplary embodiment, the probability is derived from data obtained by sensors of the transportation vehicle or from sidelink communication from other transportation vehicles. For example, RADAR (Radio Detection and Ranging) sensors, LIDAR (Light Detection and Ranging) sensors, or cameras for 2D and 3D image acquisition may be used to determine that a road is blocked. Alternatively or in addition, the automated transportation vehicle may receive relevant information from other transportation vehicles, e.g., from a transportation vehicle closer to the potential deadlock situation or from a transportation vehicle that is already being driven through the deadlock situation in a tele-operated driving session.

In an exemplary embodiment, the quality of service is predicted using previously determined data on a quality of service, data from sidelink communication from other transportation vehicles, or environment data for the location where the tele-operated driving session should be performed. The previously determined data on a quality of service may be obtained, for example, from previous measurements of the transportation vehicle or from data provided by a service provider. For example, the automated transportation vehicle may already have gathered information on the quality of service of a communication link for a particular location during previous trips, or it may receive such information from other transportation vehicles. Alternatively, a service provider may provide map data including such information. When the quality of service is predicted using environment data, these data may comprise information on buildings or locations of communication infrastructures. Based on such data, it can be analyzed whether for a particular location interferences caused by buildings are to be expected.

An autonomous or semi-autonomous transportation vehicle comprises an exemplary apparatus or is configured to perform a disclosed method for invoking a tele-operated driving session. In this way, the transportation vehicle shows an improved behavior when a tele-operated driving session needs to be invoked. The transportation vehicle may be any type of vehicle, e.g., a cars, a bus, a motorcycle, a commercial vehicles, in particular, a truck, an agricultural machinery, a construction machinery, a rail vehicle, etc. More generally, the disclosed embodiments can be used in land vehicles, rail vehicles, watercrafts, and aircrafts. This expressively includes robots and drones.

The present description illustrates the principles of the present disclosure. It will thus be appreciated that those skilled in the art will be able to devise various arrangements that, although not explicitly described or shown herein, embody the principles of the disclosure.

All examples and conditional language recited herein are intended for educational purposes to aid the reader in understanding the principles of the disclosure and the concepts contributed to furthering the art, and are to be construed as being without limitation to such specifically recited examples and conditions.

Moreover, all statements herein reciting principles and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams presented herein represent conceptual views of illustrative circuitry embodying the principles of the disclosure.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a method or mechanism for performing a specified function is intended to encompass any way of performing that function including, for example, a combination of circuit elements that performs that function or software in any form, including, therefore, firmware, microcode or the like, combined with appropriate circuitry for executing that software to perform the function. The disclosure as defined by such claims resides in the fact that the functionalities provided by the various recited methods or mechanisms are combined and brought together in the way in which the claims call for. It is thus regarded that any method or mechanism that can provide those functionalities are equivalent to those shown herein.

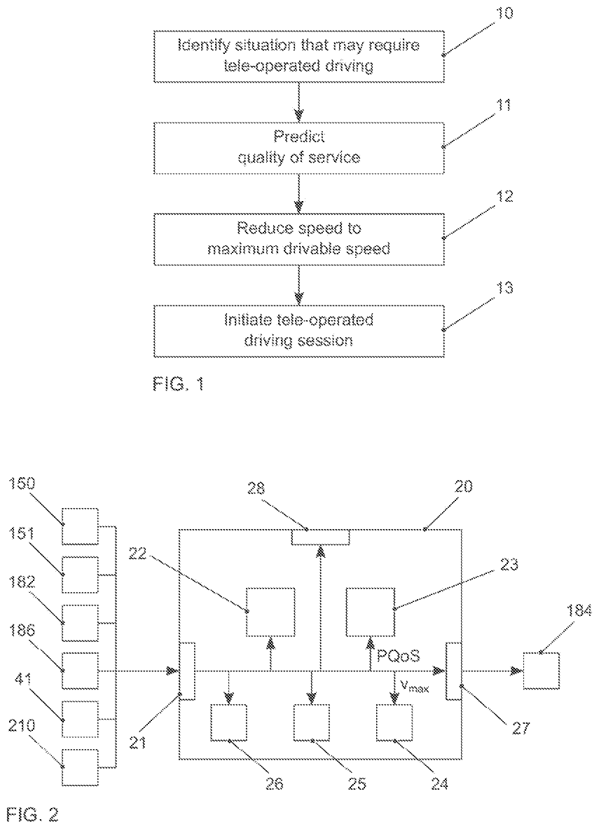

FIG. 1 schematically illustrates a disclosed method for invoking a tele-operated driving session for a transportation vehicle equipped with an automated driving function. In a first operation, an impending situation that may require a tele-operated driving session is identified 10. For this purpose, a probability may be determined that a tele-operated driving session is required. An impending situation that may require a tele-operated driving session is then identified 10 when the probability is above a first threshold. The probability may be derived from data obtained by sensors of the transportation vehicle or from a sidelink communication from other transportation vehicles. In addition, a quality of service for a communication between the transportation vehicle and a control center for a location where the tele-operated driving session should be performed is predicted 11. The quality of service may be predicted 11 using previously determined data on a quality of service, data from sidelink communication from other transportation vehicles, or environment data for the location where the tele-operated driving session should be performed. The previously determined data on a quality of service may be obtained, for example, from previous measurements of the transportation vehicle or from data provided by a service provider. The environment data may comprise information on buildings or locations of communication infrastructures. A speed of the transportation vehicle is then reduced 12 a to a maximum drivable speed for a tele-operated driving session with the predicted quality of service. Once it is confirmed that the tele-operated driving session is required, the tele-operated driving session is initiated 13. For example, it may be confirmed that the tele-operated driving session is required when a probability that a tele-operated driving session is required is above a second threshold.

FIG. 2 schematically illustrates a block diagram of a first disclosed embodiment of an apparatus 20 for invoking a tele-operated driving session for a transportation vehicle equipped with an automated driving function. The apparatus 20 has an input 21 for receiving data, e.g., from sensors 150, 151, 182, 186 of the transportation vehicle, from other transportation vehicles 41 or from a base station 210. An identifying module 22 is configured to identify an impending situation that may require a tele-operated driving session based on the received data. For this purpose, the identifying module 22 may be configured to determine a probability that a tele-operated driving session is required. An impending situation that may require a tele-operated driving session is then identified when the probability is above a first threshold. Similarly, it may be confirmed that the tele-operated driving session is required when the probability is above a second threshold. The probability may be derived from data obtained by sensors of the transportation vehicle or from a sidelink communication from other transportation vehicles. The identifying module 22 may further be configured to initiate the tele-operated driving session once it is confirmed that the tele-operated driving session is required. A predicting module 23 predicts a quality of service PQoS for a communication between the transportation vehicle and a control center for a location where the tele-operated driving session should be performed. For example, the predicting module 23 may be configured to predict the quality of service PQoS using previously determined data on a quality of service, data from sidelink communication from other transportation vehicles, or environment data for the location where the tele-operated driving session should be performed. The previously determined data on a quality of service may be obtained, for example, from previous measurements of the transportation vehicle or from data provided by a service provider. The environment data may comprise information on buildings or locations of communication infrastructures. A speed control module 24 then reduces a speed of the transportation vehicle to a maximum drivable speed vmax for a tele-operated driving session with the predicted quality of service PQoS. Control signals generated by the control module 24 or the identifying module 22 may be provided for further to an automatic driving control unit 184 via an output 27. A local storage unit 26 is provided, e.g., for storing data during processing. The output 27 may also be combined with the input 21 into a single bidirectional interface.

The identifying module 22, the predicting module 23, and the speed control module 24 may be controlled by a controller 25. A user interface 28 may be provided for enabling a user to modify settings of the identifying module 22, the predicting module 23, the speed control module 24, or the controller 25. The identifying module 22, the predicting module 23, the speed control module 24, and the controller 25 can be embodied as dedicated hardware units. Of course, they may likewise be fully or partially combined into a single unit or implemented as software running on a processor, e.g., a CPU or a GPU.

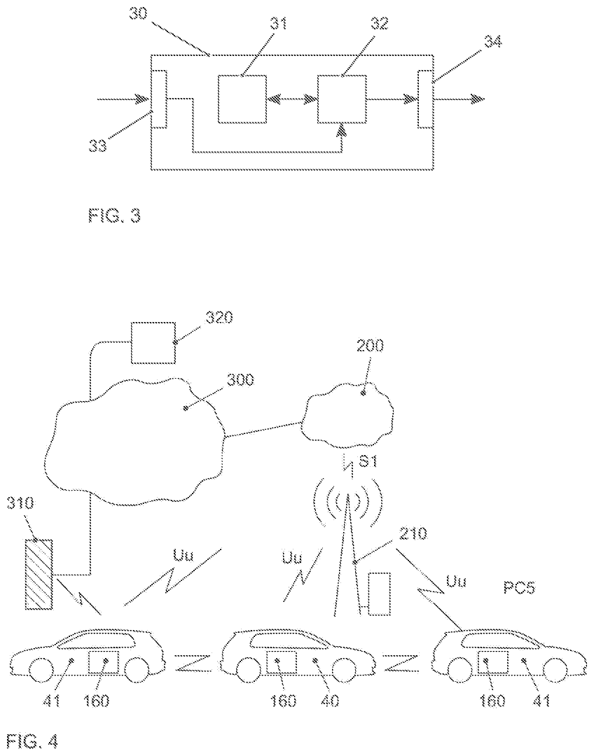

A block diagram of a second disclosed embodiment of an apparatus 30 for invoking a tele-operated driving session for a transportation vehicle equipped with an automated driving function is illustrated in FIG. 3. The apparatus 30 comprises a processing device 31 and a memory device 32. For example, the apparatus 30 may be a computer, an electronic control unit or an embedded system. The memory device 32 has stored instructions that, when executed by the processing device 31, cause the apparatus 30 to perform operations according to one of the described methods. The instructions stored in the memory device 32 thus tangibly embody a program of instructions executable by the processing device 31 to perform program operations as described herein according to the present principles. The apparatus 30 has an input 33 for receiving data. Data generated by the processing device 31 are made available via an output 34. In addition, such data may be stored in the memory device 32. The input 33 and the output 34 may be combined into a single bidirectional interface.

The processing device 31 as used herein may include one or more processing units, such as microprocessors, digital signal processors, or a combination thereof.

The local storage unit 26 and the memory device 32 may include volatile and/or non-volatile memory regions and storage devices such as hard disk drives, optical drives, and/or solid-state memories.

In the following, an exemplary embodiment shall be explained in more detail with reference to FIG. 4 to FIG. 9.

FIG. 4 illustrates a basic architecture of a V2V (Vehicle-to-Vehicle) and V2X (Vehicle-to-Everything) communication system. Reference numeral 40 denotes a transportation vehicle, which in this example is a car, in particular, a passenger car. The transportation vehicle 40 is equipped with an on-board connectivity module 160 including a corresponding antenna such that the transportation vehicle 40 can participate in any form of mobile communication service. As shown in FIG. 4, the transportation vehicle 40 may transmit and receive signals to and from a base station 210 of a mobile communication service provider using a V2N (Vehicle-to-Network) communication link Uu.

Such base station 210 may be an eNodeB (Evolved Node B) base station of an LTE mobile communication service provider or a gNB (Next Generation Node B) base station of a 5G mobile communication provider. The base station 210 and the corresponding equipment are part of a mobile communication network with a plurality of network cells, where each cell is served by one base station 210.

The base station 210 in FIG. 4 is positioned close to a main road, on which the transportation vehicle 40 is driving. Of course, other transportation vehicles 41 may also drive on the road. In the terminology of LTE, a mobile terminal corresponds to a user equipment, which allows a user to access network services, connecting to the UTRAN (UMTS (Universal Mobile Telecommunications System) Terrestrial Radio Access Network) or Evolved-UTRAN via the radio interface. Typically, such user equipment corresponds to a smart phone. Of course, mobile terminals are also used in the transportation vehicles 40, 41 as on-board connectivity modules 160. These on-board connectivity modules 160 are LTE, 5G, or any other communication modules, which enable the transportation vehicles 40, 41 to receive mobile data in downstream direction and to send such data in upstream or in direct device-to-device direction.

In terms of an LTE mobile communication system, the Evolved-UTRAN consists of a plurality of eNodeBs, providing the E-UTRA user plane protocol terminations, i.e., PDCP (Packet Data Convergence Protocol), RLC (Radio Link Control), MAC, (Medium Access Control), and PHY (Physical Layer), and the control plane protocol termination, i.e., RRC (Radio Resource Control) towards the user equipment. The eNodeBs are interconnected by the so-called X2 interface. The eNodeBs are also connected by the so-called S1 interface to an EPC (Evolved Packet Core) 200, more specifically to an MME (Mobility Management Entity) by an S1-MME interface and to a serving gateway by an S1-U interface.

In relation to this general architecture, FIG. 4 shows that the eNodeB is connected to the EPC 200 via the S1 interface and that EPC 200 is connected to the Internet 300. The control center computer 320, to which the transportation vehicles 40, 41 send messages and from which the transportation vehicles 40, 41 receive messages, is also connected to the Internet 300. In the field of cooperative and automated driving, the control center computer 320 typically is located in a traffic control center, where the operators for the tele-operated driving sessions requested by the transportation vehicles 40, 41 are working. Finally, also an infrastructure network component is shown, in this case a roadside unit 310. For the ease of implementation, it is considered that all components have assigned an Internet address, typically as an IPv6 address, such that the packets transporting messages between the components can be routed accordingly.

The various interfaces of the LTE network architecture are standardized. In this regard, reference is made to the various LTE specifications, which are publicly available for the sake of sufficiently disclosing further implementation details.

The transportation vehicles 40, 41 may also be equipped with methods or mechanisms for observing their surroundings. Their sensor systems, which are used to capture the environmental objects, are based on different measuring methods, depending on the application. Widespread technologies are, among others, RADAR, LIDAR, cameras for 2D and 3D image acquisition, and ultrasonic sensors.

Since automated driving is on the rise, a lot more data needs to be exchanged among the transportation vehicles 40, 41, e.g., using V2V communication links PC5, and also between the transportation vehicles 40, 41 and the network. The communication systems for V2V and V2X communication need to be adapted correspondingly. The 3GPP standard setting organization has been and is releasing features for the new generation of the 5G cellular mobile communication system, including V2X features. A large panel of vehicular use cases have been designed, ranging from infotainment to cooperative driving. Depending on the application, the requirement on the access link Uu in the scope of V2N communication drastically changes. When it comes to safety-related time-critical applications such as tele-operated driving, in which a command center takes over certain driving functions of the transportation vehicle, these requirements are the exchange of information with low latency, high data rate and high reliability.

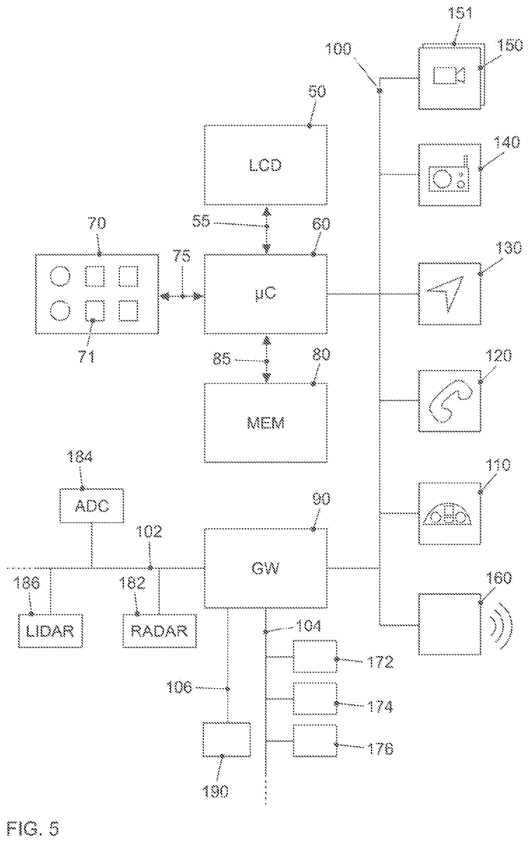

FIG. 5 schematically shows a block diagram of a board electronics system of a transportation vehicle. Part of the board electronics system is an infotainment system, which comprises a touch-sensitive display unit 50, a computing device 60, an input unit 70, and a memory device 80. The display unit 50 is connected to the computing device 60 via a data line 55 and includes both a display area for displaying variable graphical information and an operator interface (touch-sensitive layer) arranged above the display area for inputting commands by a user. The input unit 70 is connected to the computing device 60 via a data line 75. Reference numeral 71 designates a press button that allows a driver to manually request a tele-operated driving session if the transportation vehicle is blocked and the driver wants the support of a tele-operated driving operator to find a way out of the blocking situation. There is no need for a dedicated press button 71 if other techniques for manual control are used. This includes selecting an option in a user menu displayed on the display unit 50, detecting the command with speech recognition, or using gesture control method or mechanism.

The memory device 80 is connected to the computing device 60 via a data line 85. In the memory device 80, a pictogram directory and/or symbol directory is deposited with pictograms and/or symbols for possible overlays of additional information.

The other parts of the infotainment system, such as a camera 150, radio 140, navigation device 130, telephone 120 and instrument cluster 110 are connected via a data bus 100 with the computing device 60. As data bus 100, the high-speed option of the CAN (Controller Area Network) bus according to ISO standard 11898-2 may be used. Alternatively, an Ethernet-based bus system such as IEEE 802.03cg can be used. Bus systems implementing the data transmission via optical fibers are also usable. Examples are the MOST Bus (Media Oriented System Transport) or the D2B Bus (Domestic Digital Bus). For inbound and outbound wireless communication, the transportation vehicle is equipped with an on-board connectivity module 160. It can be used for mobile communication, e.g., mobile communication according to the 5G standard.

Reference numeral 172 denotes an engine control unit. Reference numeral 174 denotes an ESC (electronic stability control) unit, whereas reference numeral 176 denotes a transmission control unit. The networking of such control units, all of which are allocated to the category of the drive train, typically occurs with a CAN bus 104. Since various sensors are installed in the transportation vehicle and these are no longer only connected to individual control units, such sensor data are also distributed via the bus system 104 to the individual control devices.

Modern transportation vehicles may comprise additional components, such as further sensors for scanning the surroundings, like a LIDAR sensor 186 or a RADAR sensor 182 and additional video cameras 151, e.g., a front camera, a rear camera or side cameras. Such sensors are increasingly used in transportation vehicles for observation of the environment. Further control devices, such as an ADC (automatic driving control) unit 184, etc., may be provided in the transportation vehicle. The RADAR and LIDAR sensors 182, 186 may have a scanning range of up to 250 m, whereas the cameras 150, 151 may cover a range from 30 m to 120 m. The components 182 to 186 are connected to another communication bus 102, e.g., an Ethernet-Bus due to its higher bandwidth for data transport. One Ethernet-bus adapted to the special needs of car communication is standardized in the IEEE 802.1Q specification. Moreover, a lot of information about the environment may be received via V2V communication from other transportation vehicles. For those transportation vehicles that are not in line of sight to the observing transportation vehicle, it is very beneficial to receive the information about their position and motion via V2V communication.

Reference numeral 190 denotes an on-board diagnosis interface, which is connected to another communication bus 106.

For the purpose of transmitting the vehicle-relevant sensor data via the an on-board connectivity module 160 to another transportation vehicle or to a control center computer, a gateway 90 is provided. This gateway 90 is connected to the different bus systems 100, 102, 104 and 106. The gateway 90 is adapted to convert the data it receives via one bus to the transmission format of another bus so that it can be distributed using the packets specified for the respective other bus. For forwarding this data to the outside, i.e., to another transportation vehicle or to the control central computer, the an on-board connectivity module 160 is equipped with a communication interface to receive these data packets and, in turn, to convert them into the transmission format of the appropriate mobile radio standard.

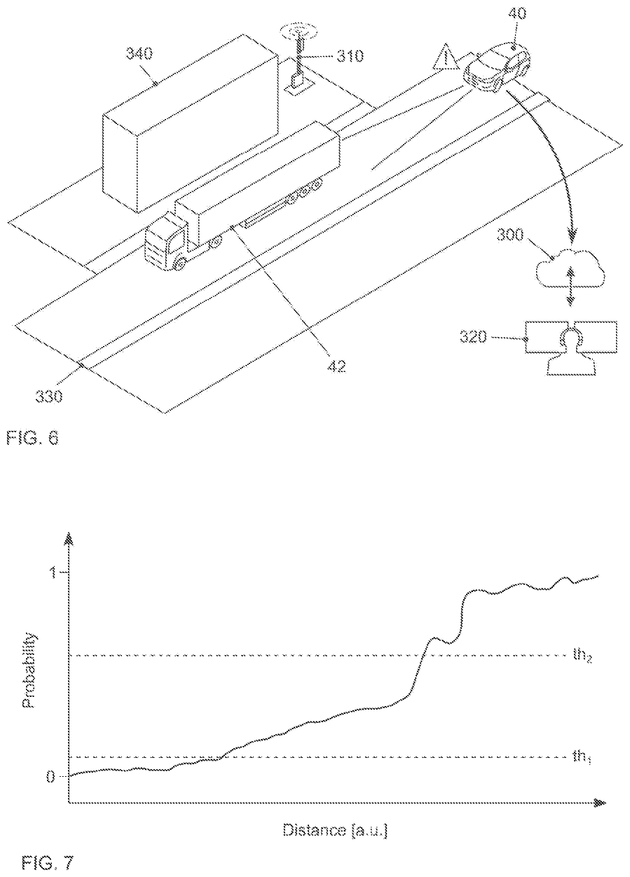

FIG. 6 shows an exemplary deadlock situation as an application scenario of tele-operated driving. A truck 42 is blocking a one-way road. The succeeding transportation vehicle 40 is an automated transportation vehicle with Level 4 or Level 5 automated driving capability in the need to pass this obstacle. The automated driving functionality needs to respect all the traffic regulations, including traffic signs and traffic lights, etc. Since it is not an option for the automated driving function to drive over the sidewalk 330 to pass the truck 42, the transportation vehicle 40 would remain behind the truck 42 and wait until the truck 42 moves on. This, however, could take hours, e.g., if the truck 42 is stopping inadvertently due to a breakdown or a road accident. To overcome this deadlock situation, the transportation vehicle 40 needs to drive over the sidewalk 330 to continue its planed route. To this end, a tele-operated driving session needs to be invoked at a control center computer 320 using a connection via a roadside unit 310 and the Internet 300. According to present solutions for tele-operated driving, the transportation vehicle 40 would stop, contact the control center and then reach the maximum drivable speed in consideration of the situation and information on the quality of service for communication during the tele-operated driving session. As can be seen, a building 340 constitutes an obstacle for the communication with the roadside unit 310, i.e., the quality of service will be negatively affected by this building 340.

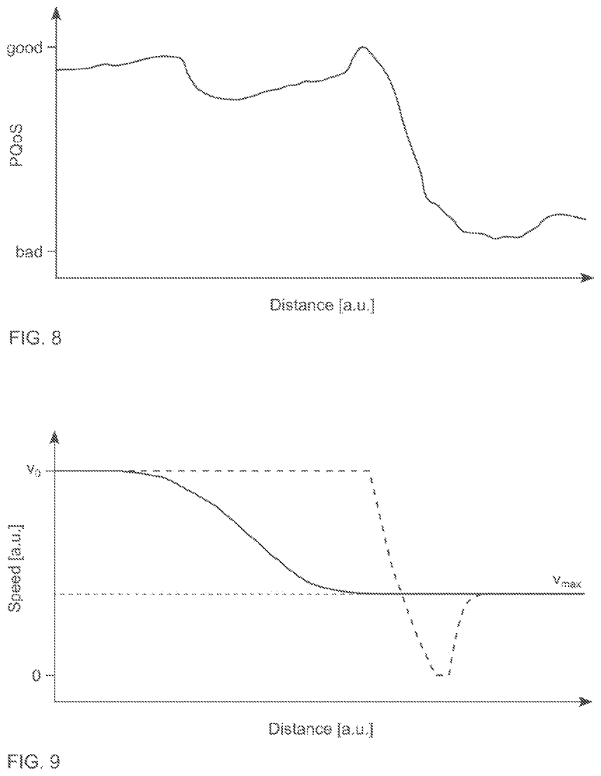

In contrast, according to the present solution, when the automated transportation vehicle 40 approaches the deadlock situation, it first identifies an impending situation that may require a tele-operated driving session. For this purpose, the automated transportation vehicle 40 may continuously determine and evaluate a probability of a deadlock along its path. Such an estimated probability of a deadlock for the situation of FIG. 6 is shown schematically in the graph in FIG. 7. As can be seen, the probability increases along the path. When the probability of a deadlock exceeds a first threshold th1, the automated transportation vehicle 40 further gathers information on a predicted quality of service PQoS for a communication between the transportation vehicle 40 and the control center. Of course, the predicted quality of service PQoS may likewise be determined continuously, irrespective of any probability of a deadlock. The predicted quality of service PQoS for the situation of FIG. 6 is shown schematically in the graph in FIG. 8. As can be seen, there is a drop in the predicted quality of service PQoS due to the presence of the building 340. As the drop in the predicted quality of service PQoS coincides with the increase of the probability of a deadlock, the automated transportation vehicle 40 changes its driving settings to target the maximum drivable speed vmax in a tele-operated driving session in this environment. Additionally, the automated transportation vehicle 40 prepares the tele-operated driving session as soon as it is confirmed that the deadlock will occur, e.g., because the probability of a deadlock is above a second threshold th2. Reducing the speed to the maximum drivable speed vmax for a tele-operated driving session and initiating the tele-operated driving session in advance avoids the emergency brake and waiting time that would occur without the present solution. A comparison between a speed profile with the present solution (solid line) and a speed profile without the present solution (dashed line) is shown in FIG. 9. The initial speed of the transportation vehicle as it approaches the deadlock situation is v0.

### REFERENCE NUMERALS

10 Identify situation that may require tele-operated driving
11 Predict quality of service
12 Reduce speed to maximum drivable speed
13 Initiate tele-operated driving session
20 Apparatus
21 Input
22 Identifying module
23 Predicting module
24 Speed control module
25 Controller
26 Local storage unit
27 Output
28 User interface
30 Apparatus
31 Processing device
32 Memory device
33 Input
34 Output
40 Transportation vehicle
41 Other transportation vehicle
42 Truck
50 Display Unit
55 Data line to display unit
60 Computing device
70 Input unit
71 Press button
75 Data line to input unit
80 Memory unit
85 Data line to memory unit
90 Gateway
100 First data bus
102 Second data bus
104 Third data bus
106 Fourth data bus
110 Instrument cluster
120 Telephone
130 Navigation device
140 Radio
150 Camera
151 Further cameras
160 On-board connectivity module
172 Engine control unit
174 Electronic stability control unit
176 Transmission control unit
182 RADAR sensor
184 Automatic driving control unit
186 LIDAR sensor
190 On-board diagnosis interface
200 Evolved packet core
210 Base station
300 Internet
310 Roadside unit
320 Control center computer
330 Sidewalk
340 Building
PC5 V2V communication link
PQoS Predicted quality of service
S1 S1 interface
Uu V2N communication link

1. A method for invoking a tele-operated driving session for a transportation vehicle equipped with an automated driving function, the method comprising:
identifying an impending situation that requires a tele-operated driving session;
predicting a quality of service for a communication between the transportation vehicle and a control center for a location where the tele-operated driving session will be performed; and
reducing a speed of the transportation vehicle to a maximum drivable speed for a tele-operated driving session with the predicted quality of service.

2. The method of claim 1, further comprising initiating the tele-operated driving session in response to confirmation that the tele-operated driving session is required.

3. The method of claim 1, further comprising determining a probability that a tele-operated driving session is required, wherein an impending situation that requires a tele-operated driving session is identified when the probability is above a first threshold.

4. The method of claim 3, wherein confirmation that the tele-operated driving session is required is based on the probability being above a second threshold.

5. The method of claim 3, wherein the probability is derived from data obtained by sensors of the transportation vehicle or from sidelink communication from other transportation vehicles.

6. The method of claim 1, wherein the quality of service is predicted using previously determined data on a quality of service, data from sidelink communication from other transportation vehicles, or environment data for the location where the tele-operated driving session will be performed.

7. The method of claim 6, wherein the previously determined data on a quality of service are obtained from previous measurements of the transportation vehicle or from data provided by a service provider.

8. The method of claim 6, wherein the environment data comprise information on buildings or locations of communication infrastructures.

9. A non-transitory computer readable medium including a computer program comprising instructions, which, when executed by a computer, cause the computer to perform the method of claims of claim 1 for invoking a tele-operated driving session for a transportation vehicle equipped with an automated driving function.

10. An apparatus for invoking a tele-operated driving session for a transportation vehicle equipped with an automated driving function, the apparatus comprising:
an identifying module to identify an impending situation that requires a tele-operated driving session;
a predicting module configured to predict a quality of service for a communication between the transportation vehicle and a control center for a location where the tele-operated driving session will be performed; and
a speed control module configured to reduce a speed of the transportation vehicle to a maximum drivable speed for a tele-operated driving session with the predicted quality of service.

11. A transportation vehicle equipped with an automated driving function, wherein the transportation vehicle comprises the apparatus of claim 10.

12. The apparatus of claim 10, wherein the tele-operated driving session is initiated in response to confirmation that the tele-operated driving session is required.

13. The apparatus of claim 10, wherein a probability that a tele-operated driving session is required is determined, wherein an impending situation that requires a tele-operated driving session is identified when the probability is above a first threshold.

14. The apparatus of claim 13, wherein confirmation that the tele-operated driving session is required is based on the probability being above a second threshold.

15. The apparatus of claim 13, wherein the probability is derived from data obtained by sensors of the transportation vehicle or from sidelink communication from other transportation vehicles.

16. The apparatus of claim 10, wherein the quality of service is predicted using previously determined data on a quality of service, data from sidelink communication from other transportation vehicles, or environment data for the location where the tele-operated driving session will be performed.

17. The apparatus of claim 16, wherein the previously determined data on a quality of service are obtained from previous measurements of the transportation vehicle or from data provided by a service provider.

18. The apparatus of claim 6, wherein the environment data comprise information on buildings or locations of communication infrastructures.
